(19) United States
(12) Patent Application Publication
(10) Pub. No.: US 2007/0174854 A1
(43) Pub. Date: Jul. 26, 2007

(54) STORAGE MEDIUM FOR CONFIDENTIAL INFORMATION

(76) Inventors: Hardy Jungermann, Dusseldorf (DE); Ralf Dujardin, Willich (DE); Stephan Volkening, Koln (DE)

Correspondence Address: Womble Carlyle Sandridge & Rice, PLLC;Attn: Patent Docketing 32nd Floor, P.O. Box 7037, Atlanta, GA, 30357-0037, US

(21) Appl. No.: 11/470,073

(22) Filed: Sep. 5, 2006

(30) Foreign Application Priority Data
Sep. 5, 2005 (DE) 102005042246.2

(51) Int. Cl. G11B 33/02

(52) U.S. Cl. 720/600

(57) ABSTRACT

The present invention relates to a storage medium comprising a storage layer of a photoaddressable polymer (PAP), a method for storing data in a storage layer of a photoaddressable polymer as well as to uses of a storage medium.

### CROSS REFERENCE TO RELATED APPLICATIONS

The instant application claims priority to German Application Number 102005042246.2 filed Sep. 5, 2005, the content of which is incorporated herein by reference in its entirety.

### BACKGROUND OF THE INVENTION

1. Field of the Invention

The present invention relates generally to a storage medium comprising a storage layer of a photoaddressable polymer (PAP), preferably having a storage capacity of more than about 5 KByte/mm². Information can be stored in the storage medium in the form of invisible holograms which are safe from falsification, manipulation and copying and are therefore particularly suitable for the storage of information worthy of protection.

The invention furthermore relates to a method for storing information in the storage medium according to the invention in the form of holograms which are invisible to the human eye. The storage medium can optionally be protected from unwanted access by an analogue encryption. The storage medium is suitable for a multiplicity of applications; owing to its properties, it is especially useful for pass systems and ID cards. The invention accordingly also relates to the use of the storage medium according to the invention in passes and ID cards for holding personal data and/or for storage information worthy of protection in flat media, such as passes, ID cards and/or paper documents.

2. Description of Related Art

There is a multiplicity of situations in which a person has to provide information about his or her identity and prove the correctness of the data. Identity documents, passes and ID cards constitute an established instrument used worldwide. Owing to the increasing data processing by machine, a person may now have a multiplicity of ID cards used for various purposes. For example, many people carry a personal identity card, a driver's license and often an accompanying pass, a passport, a health insurance card(s), one or more credit or EC cards—all instruments by means of which an individual proves his identity. These instruments generally carry certain confidential data and are used to entitle a person to certain actions or provide rights to certain services.

Common to almost ID/pass systems mentioned above is the fact that there is a unique coordination between the pass and owner. For this purpose, personal data and/or features (e.g. passport photo, personal number/social security number, age, height or the like) of the owner are recorded on or in the pass. The identity of a person is determined (identification) or checked (verification) on the basis of these features.

In the course of increasing automation, machine-readability of the passes is required. Checking the authenticity of the pass is also sometimes best effected automatically. Furthermore, automated recognition of the holder may be required. Characteristic features of a person, so-called biometric features, which are intended to ensure unambiguous assignment to a person, e.g. fingerprint, iris pattern, hand geometry, facial image and/or voice or other characteristics, are used for this purpose. The biometric features may be stored centrally in a database in the form of reference data or (decentrally) on the pass itself. For reasons relating to the data protection law in some countries, decentral storage is generally preferable, and thus, the pass should have a suitable storage medium.

Biometric features typically require more memory than bibliographic data. If the recommendations of the ICAO (International Civil Aviation Organization) for machine-readable passports are taken as a basis (ICAO TAG MRTD/NTWG Technical Report Version 2.0: Development and Specification of Globally Interoperable Biometric Standards for Machine Assisted Identity Confirmation using Machine Readable Travel Documents, http://www.icao.int/mrtd/biometrics/recommendation.cfm), the following memory requirement results: 12 K for images for face recognition, 10 K for images for fingerprints, 30 K for images for iris recognition.

The reliability of a biometric match, i.e. of the comparison of the biometric data of a person with the reference data on the card, can be increased by using a plurality of reference data records. In the case of facial recognition, for example, a plurality of images can be recorded and stored. During matching, the actual face is then compared with all images of the stored data record. The so-called false rejection rate (FRR) is thus reduced. Sufficient memory space must be available for this purpose.

This also applies when using multiple biometries. In many people, for example, the dermal lines on the fingertips are not very pronounced so that authentication on the basis of the fingerprint poses difficulties. In this case, it should be possible to use an alternative biometric feature for authentication, for example the iris pattern. The storage capacity of an ID card which is used for automated authentication on the basis of biometric features should therefore have a storage capacity of at least 100 KBytes, but most preferably more.

The health card is a special pass. The health card is ideally intended to be able to store a patient's history of illness so that any doctor immediately knows the history of a patient, in order to avoid duplicated examinations. This includes, for example, the storage of X-ray images. The memory volume of X-ray images is in the region of MBytes. The required memory capacity of a health card is therefore higher than in the case of other identity cards. A health card on which all data are stored decentrally has the advantage over central data storage that the patient himself has the data and can himself decide who he allows to inspect his medical data.

In many areas of the world, plastic cards have become established as ID cards. The ID-1 format, which is characterized in the standard ISO/IEC 7810 (“credit card format”), is particularly widespread. It is of a convenient size and can be accommodated in purses and wallets. There are many card readers which are designed for this format. A storage medium which is to be used in passes and ID cards should be capable of being integrated in such a plastic card of ID-1 format according to ISO/IEC 7810.

However, it should also be possible to equip other formats with the storage medium. Visa documents constitute a special format. These are generally present in paper form. It would be desirable if visa documents could be equipped with biometric features of the person desiring entry. For this purpose, a visa document in paper form would have to be capable of being provided with a storage medium for at least 100 KB.

Information which is stored in the memory should be secure from unauthorized access. Biometric features or medical information constitutes sensitive data which could be misused. One possibility for protection from unwanted access is encryption. Where data are present in digital form, they can be digitally encrypted. Access is possible only with the knowledge of the key.

However, in addition to the possibility of encryption, there should also be copy protection in order to prevent a parallel brute force attack. In a brute force attack, an attempt is made to decrypt the digitally encrypted information with the aid of a computer by trying all possible keys. The time required for cracking the system in this way is given by the number of possible keys multiplied by the time for trying out a key. The computing operations of a computer are very fast and the performance doubles roughly every year (Moore's Law).

Digital information can be copied as often as desired without loss and without the content having to be known. There is therefore the possibility of attempting the brute force attack in parallel: the encrypted information is copied several times and subjected to an attack on a plurality of computers. A different set of keys is tried on each computer. This makes it possible to reduce the time for a successful attack (particularly in the age of network computers). Copying protection would suppress the parallel attack. In addition to copy protection, protection from manipulation and/or falsification of the stored data should also be present.

In summary, there is a need for a storage technology which makes it possible to store at least 100 KB, preferably several MBytes, of confidential data in a manner which is safe from falsification and protected from unwanted access. The unauthorized production of a copy of the data should be prevented. The storage medium should be capable of being applied to a multiplicity of formats, inter alia plastic cards and paper documents.

A number of different memory cards are commonly used as ID cards, such as highly embossed cards, barcode cards, magnetic stripe cards and chip cards. The choice of the storage medium is determined by the application. Highly embossed cards and barcode cards, simple or matrix codes, are data media of low storage capacity (100-several thousand characters) and can easily be copied.

In chip cards, data are stored digitally and are protected from unwanted reading and deleting by the integrated access logic. The integrated microcontroller makes it possible to carry out cryptographic calculations. The storage capacity is limited by the maximum size of the chip, and its production is expensive. These types of chips are typically monocrystalline semiconductor memories which are generally limited to a size of not more than 25 mm², since they can otherwise easily break owing to bending of the card. Chip cards having a storage capacity of 16 to 72 KBytes are commonly used.

Memory cards which can be read optically have the highest storage capacities. US Published Application No. 2003136846 describes an optical memory card which is derived from an optical storage disc (CD, DVD). The card can be read on a standard CD or DVD player with the aid of an adapter. The storage capacity is 100-200 MBytes. However, the card has no protection mechanisms to prevent unwanted reading and/or copying. Anyone who comes into possession of the card can read it with the aid of the adapter in a DVD player and reproduce it using a DVD burner.

U.S. Pat. No. 4,360,728 describes a further type of optical memory card. The storage layer has the form of a stripe which is preferably arranged parallel to the longitudinal axis of the memory card. The data are arranged in the stripe not in spiral form as on a storage disc but linearly along the stripe. WO8808120 (A1) describes an apparatus by means of which the storage layer can be written on and read.

Anyone in possession of this apparatus can read and/or copy the data. The storage capacity is a few MBytes.

In both optical storage cards mentioned supra, the data are present digitally in the form of so-called pits in the storage layer. These pits can, in principle, be read using a microscope and can be translated into digital data. As soon as the data are read into a computer, they can be copied. Furthermore, a computational Brute Force Attack as described above is possible. There is no effective copy protection, as is required.

Protection from reading the microscopically visible digital data can be provided by holographic data storage. In holographic data storage, two laser beams are superposed in the storage material. Data to be stored holographically are superposed on one beam (information beam), for example using a data mask. The other beam (reference beam) is caused to interfere with the information beam in the material. The interference pattern is stored in the storage material. During reading, the hologram is illuminated with the reference beam. The information beam is reproduced and an image of the stored information (object) can be focused onto a photosensitive sensor (cf. FIG. 1).

The storage of information in the form of holograms is a method of encryption. Holographic data storage has been known for many years. In 1949, the Hungarian physicist Dennis Garbor discovered holography. After the invention of the laser in 1960, holograms, i.e. three-dimensional images of objects, were successfully produced (http://www.holographie-online.de/wissen/einfuehrung/geschichte/geschichte.html). The method for producing holograms using a laser beam split into reference beam and object beam has thus been part of the prior art for many years. The possibilities and advantages of storing information in the form of holograms are also quickly recognized and have since been often described in the literature. See for example, (http://www.enteleky.com/holography/litrew.htm).

Holographic storage technology also offers a further option of having analogue hardware encryption. In FIG. 1, it is shown that an image beam is reproduced only when there is a match in properties between the “reading” beam and the reference or “writing” beam that was used when the hologram(s) was created. There is therefore the possibility of analogue encryption. If the reference beam is modulated in a characteristic manner during writing of a hologram, this same modulation must also be used during reading. Otherwise, the information beam cannot be reproduced and the stored information cannot be read. Thus, holograms can be provided with analogue encryption (cf. FIG. 2). Identity cards in which the identification features are applied in the form of an encrypted hologram are described, for example, in U.S. Pat. No. 3,894,756. The data are “hardware-encrypted” and can therefore also be read again only by means of the correct hardware.

There are various methods for producing holograms, for example, as amplitude or phase holograms. In the case of the amplitude hologram, the interference pattern is recorded as a blackening pattern in the storage material. During reconstruction, the reference wave absorbs proportionally to the local blackening (reduction of the amplitude). In a typical phase hologram, the interference pattern is recorded as a refractive index pattern in the storage material. During reconstruction, the reference wave experiences a phase shift proportional to the local refractive index. Other types of phase hologram use variations of layer thickness or surface relief in order to produce phase differences in the reference wave.

Common to all abovementioned holograms is that the diffracting structures are visible to the human eye. In principle, the structures can be read using a microscope and an attempt can be made with the aid of a computer to recalculate the holographically coded information from the holograms. It would therefore be advantageous if the holographic structures were invisible to the human eye.

In addition, the phase and amplitude holograms described can be copied. A known method is so-called Contact Printing (cf., for example P. Hariharan: Basics of Holography, University Press Cambridge (2002)).

In addition to amplitude and phase holograms, there are also so-called polarization holograms. These can be realized only in special storage media. Media which can store the polarization state of a light wave are suitable as storage material. These are, for example, polymers which carry azobenzene-containing side chains, so-called photoaddressable polymers (PAP). On illumination with polarized light, the side chains undergo orientation perpendicular to the polarization direction (Photoorientation, cf. FIG. 3). This effect can be used for data storage (R. Hagen, T. Bieringer: Photoaddressable Polymers for Optical Data Storage. In: Advanced Materials, WILEY-VCH Verlag GmbH (2001), No. 13/23, pages 1805-1810).

For writing polarization holograms in photoaddressable polymers, circularly polarized laser beams can be used as information beam and reference beam. On superposition of the part-beams in the storage medium, a linearly polarized beam which determines the orientation of the photoactive groups in the polymer results from the two beams polarized circularly in opposite directions. This form of polarization holography is described in WO 99/57719A1. The method and a device for storing Fourier polarization holograms are claimed.

Polarization holograms based on so-called photoaddressable polymers have been disclosed in the prior art. The prior art also discloses that azobenzene-containing polymers form on illumination of surface structures (A. Natansohn, P. Rochon; Photoinduced Motions in Azo-Containing Polymers; Chem. Rev. 2002, 102, 4139-4175). As a result of using a photoinduced process well below the glass transition temperature of the material, molecules and molecular groups are transported within the polymer film and deposited at defined points. The resulting surface structure is visible under a microscope. Holographic structures in photoaddressable polymers based on azobenzene-functionalized side chain polymers according to the prior art are therefore also visible and capable of being copied.

The surface structures appear more clearly the more intense the irradiation with light. However, writing holographic structures with low light intensities is not a solution to the problem since the holographic structures are not stable over time thereby. This is described, for example, in DE4431823, Example 1 (pages 6, 7).

### SUMMARY OF THE INVENTION

Starting from the prior art, a technical object of the present invention was to develop a storage medium which, in combination with a holographic storage technique, makes it possible to store at least 100 KB, preferably several MBytes, of confidential data, for example biometric features in a forgery-proof manner and with protection from unwanted access. Unauthorized production of a copy of the data is to be prevented. The storage medium should advantageously have a storage layer which can be written on and read holographically, and which can be applied in various sizes to a multiplicity of substrates, inter alia plastic cards and paper documents.

It was surprisingly found that the above technical object can be achieved, for example, by an optical storage medium comprising at least one storage layer of a photoaddressable polymer, and by a storage method by means of which invisible polarization holograms can be stored in the storage medium according to the invention.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

FIG. 1: Schematic diagram of a holographic storage method.
(a) The information is written in the form of data masks. It is not the data page itself that is stored but the holographically encrypted data page.
(b) In order to read a hologram, it is exposed to a beam which has the same properties as the reference beam during writing. The beam is diffracted at the hologram, the information beam being reconstructed. An image of the data page is thrown onto a camera chip, where it can be electronically further processed.

FIG. 2: Schematic diagram of the hardware encryption in holographic data storage. Only if the reference beam is modulated with the correct key mask can the previously written data mask be reconstructed. (a) Writing an encrypted hologram; (b) reading the encrypted hologram.

FIG. 3: On exposure to polarized laser light, the polymer molecules in the storage material are oriented. The orientation is retained even when the light is switched off, so that information can be written in this manner.

FIG. 4: Schematic diagram of transmission holography and of the corresponding layer structure for the corresponding storage medium.

FIG. 5: Schematic diagram of reflection holography and of the corresponding layer structure for the corresponding storage medium.

FIG. 6: Characteristic absorption spectrum of a 400 nm thick layer of a photoaddressable polymer.

FIG. 7: Exposure curve of an azobenzene-functionalized polymer (cf. also Example 1). The change in the refractive index which was measured using a red laser at 633 nm is plotted along the ordinate. Exposure was effected with an intensity of 1000 mW/cm². The layer thickness of the PAP was 0.58 μm.

FIG. 8: Dimensions preferred in terms of marketing aspects for the particular ID card execution of Example 5. Plastic card in the form of a credit card on which a PAP is applied in the usual position of the magnetic stripe in EC cards.

FIG. 9: Nub structuring of the memory card. While an unstructured card has a curved surface on bending (a) the area elements of the raised regions continue to be flat in the case of a structured card (b). Holograms which are positioned on these “nubs” can still be satisfactorily read even in the case of curved cards.

FIG. 10: Polyurethane card produced by vacuum casting with special nub structuring: square elevations having the dimensions 3 mm×3 mm×0.5 mm and a spacing of 2 mm. The total height of the card was 1 mm.

FIG. 11: Image on the camera chip of a holographic read setup: holographically stored and optically read data page. A multiplicity of white elements (pixels) is recognizable on a black background. The pixels represent a data code having marking points and error correction.

FIG. 12: diagram showing the influence of light intensity/exposure time on the visibility of holograms in photoaddressable polymers. Holograms were written using the following parameters: (a) 1 W/cm²×1000 sec=1000 J/cm², (b) 1 W/cm²×500 sec=500 J/cm², 1 W/cm²×100 sec=(c) 100 J/cm². In the case of high energy inputs (per unit area), the hologram is clearly visible (a), (b). In these cases, the effect of surface structuring occurs in addition to the desired orientation of the photoaddressable polymers. Only in the case of smaller quantities of energy (c) is the hologram no longer distinguishable from the background; it is invisible to the human eye.

### DETAILED DESCRIPTION OF A PREFERRED EMBODIMENT

In principle, all polymers into which a directed birefringence can be written are suitable as a storage layer (See, i.e. Polymers As Electroopotical and Photooptical Active Media, V. P. Shibaev (editor), Springer Verlag, New York 1995; Natansohn et al., Chem. Mater. 1993, 403-411, the content of which is incorporated herein by reference). The birefringence pattern written can be visualized in polarized light.

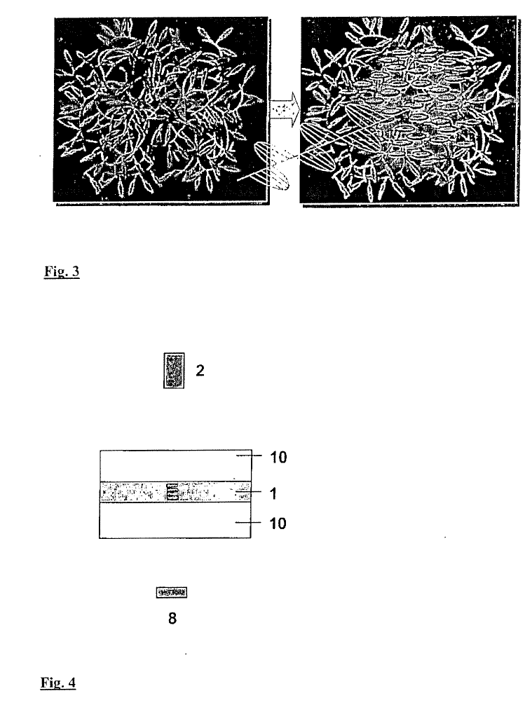

A localized birefringence whose preferred axis also moves on rotation of the direction of polarization can be written by targeted exposure. Examples of these photoaddressable polymers are polymers having azobenzene-functionalized side chains, which are described, for example, in U.S. Pat. No. 5,173,381, which is incorporated herein by reference. On exposure to polarized light, the photoactive azobenzene groups in the azobenzene-functionalized polymer are aligned perpendicular to the polarization direction (Photoorientation, cf. FIG. 3).

Further members of the photoaddressable polymers which may be used for the present invention are described in the following publications: EP0622789B1 (pages 3-5), DE4434966 A1 (pages 2-5), DE19631864 A1 (pages 2-16), DE19620588 A1 (pages 3-4), DE19720288 A1 (pages 2-8), DE4208328 A1 (pages 3, lines 3-4,9-11, 34-40, 56-60), DE10027153 A1 (page 2-page 8, line 61), DE10027152 A1 (pages 2-8), WO 196038410 A1, U.S. Pat. No. 5,496,670 Section 1, lines 42-67, Section 6, line 22 to Section 12, line 20), U.S. Pat. No. 5,543,267 (Section 2, line 48 to Section 5, line 3), EP0622789 B1 (page 3, line 17 to page 5, line 31), WO9202930 A1 (page 6, lines 26 to 35, page 7, line 25 to page 14, line 20), WO1992002930 A1.

Polymers in which birefringence can be induced by exposure to polarized light having a wavelength in the range from 320 to 700 nm, particularly preferably in the range from 400 to 550 nm, are preferably used.

The storage density of a layer of photoaddressable polymer is generally limited by the wavelength L of the light which is used for writing. The theoretical storage density is 1/L². With the use of a blue light source (400 nm), the storage density is therefore 6.25 MBit/mm²; in the case of a green light source (530 nm), it is accordingly 3.55 MBit/mm². It is thus possible to produce a storage medium having a storage capacity of at least 100 KByte to several MByte.

In principle, the total surface of the storage medium can be used for the storage layer since the layer is applied as a thin film. For the use of a card having the size of a standard credit card, it is therefore theoretically possible to realize a storage capacity of up to about 15.5 GBit.

The storage layer and optionally the storage medium can be reduced to the size of an individual hologram. The size of the hologram written is preferably at least 0.01 mm², more preferably from 0.05 mm² to 5 mm² and particularly preferably from 0.07 mm² to 1.5 mm².

A storage medium having the size of about 0.03 mm² is suitable for storing about 5 KB of data. Such a storage medium can be applied, for example, to items of jewelry, tablets, and other high-value objects or objects to be protected from falsification for other reasons.

Information is stored in the form of polarization holograms in the storage medium. The storage material and the storage method ensure that the information is invisible to the human eye and hence protected from falsification, copying, manipulation and unwanted reading. It is not possible to see from the outside of the storage medium whether and where information is stored. A copy of the written hologram by means of Contact Printing (P. Hariharan: Basics of Holography, University Press Cambridge, 2002) is also typically ruled out in the case of the present polarization holograms.

The storage medium preferably comprises at least three layers: a substrate, the storage layer of photoaddressable polymer and one or more protective layers.

Depending on the arrangement of the laser source and detector during reading of the stored information, a distinction can be made between two fundamental layer structures.

In transmission holography (FIG. 4), laser source and detector are present on different sides of the storage medium, and the laser beam/reference beam should pass through the storage medium. The storage layer is typically introduced between two single-stratum or multistratum protective layers, and one of them generally serves as a substrate. Here, the protective layers ensure the necessary stability of the storage medium and protect the storage polymer from mechanical loads (e.g. scratches). These protective layers should be transparent to the light for reading and (at least the layer facing the laser) to the light for writing.

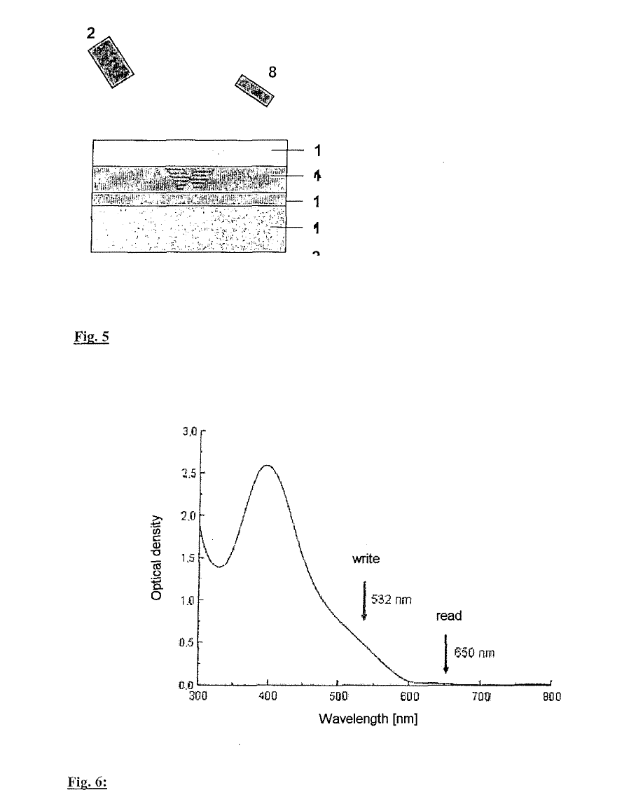

In reflection holography (FIG. 5), the stored information is read from the storage medium in reflection, i.e. the laser source and detector are present on the same side of the storage medium. The storage medium generally comprises at least four layers; in addition to the layers mentioned in the case of transmission holography, there is also a reflection layer, which can be introduced between the substrate and the storage layer. Alternatively, the reflection layer may also be applied on that side of the substrate which is opposite the storage layer; in this case, the substrate should be transparent to the light for reading.

In reflection holography, the substrate may be opaque to light for reading and for writing; the protective layer facing the laser should be transparent to light for reading and for writing. In transmission holography and in reflection holography, the protective layers through which a laser beam passes during reading should have low scattering and low birefringence. The holograms are preferably read in reflection.

The substrate on which reflection layer and storage polymer are applied may be of any desired material which has a flat surface on which the reflection layer is applied flat. Flat surface is understood as meaning those surfaces which have little roughness. Rough surfaces lead to scattering of the laser beam, which may present problems during reading of the stored information. The roughness of surfaces can be determined by means of stylus methods (measuring instrument: KLA Tencor Alpha Step 500; method of measurement: MM-40001). The surface roughness is preferably below about Rₐ, =100 nm.

Possible materials for the substrate include glass, metal or polymers. In particular acrylonitrile-butadiene-styrene (ABS), polycarbonate (PC), PC-ABS blends, polyethylene terephthalate (PET), polyethylene naphthalate (PEN), polyvinyl chloride (PVC), polymethyl methacrylate (PMMA), polyester (PE), polypropylene (PP), cellulose, polyimide (PI) and polyamide (PA). ABS, PVC, PE, PET, PC, PA and/or blends of these materials are particularly preferred. A polymer which can be processed to give a film is particularly preferred (cf. J. Nentwig, Kunststoff-Folien, 2nd edition, Hanser-Verlag, 2000, pages 29-31, page 39, pages 43-63), which is incorporated herein by reference.

The reflection layer forms a wavelength-selective mirror which reflects the reference beam of the wavelength for reading. The reflection layer preferably comprises a metal or an alloy, particularly preferably aluminium, gold, copper, bismuth, silver, titanium, chromium and/or an alloy which has one of these elements as a noticeable component and/or as a main constituent.

The average reflectivity in the visible (VIS) and near infrared (NIR) spectral range is preferably at least 50%, more preferably at least 80%, particularly preferably at least 90%. Materials which maintain high reflectivity over a long period (at least 3 years) are preferably used. The reflection layer can be applied to the substrate by any suitable method such as by vapor deposition, CVD (chemical vapor deposition), PVD (physical vapor deposition), sputtering, galvanizing and/or other methods. The reflection layer is preferably applied by sputtering or vapor deposition.

The thickness of the reflection layer should preferably be at least 50 nm and is preferably between 80 nm and 1 μm. Commercially available metallized thermoplastic films may also be used as a combination of substrate and reflection layer if desired for any reason. The reflective layer may be developed as a multilayer structure in which the chosen reflectivity is achieved by targeted multiple reflections in its layer structure.

In order to produce particularly good optical quality, it is possible to apply material to the substrate one or several times by vapor deposition or sputtering and to clean the substrate between the metallization steps in order to minimize the number of pinholes.

The storage layer of photoaddressable polymer can be applied from a solution by known techniques, such as, for example one or more of the following, spin-coating, spraying, coating with a doctor blade, dipcoating, screen printing, dipping, pouring, etc. The layer thicknesses of the resulting films are typically between 10 nm and 50 μm, preferably between 30 nm and 5 μm, particularly preferably between 200 nm and 2 μm.

One or more protective layers can advantageously be applied to the storage layer. These protective layer(s) are intended to protect the storage layer from scratching or other environmental influences, such as, for example, moisture. A so-called protective coating is preferably used as a protective layer for the optical data storage. The protective coating can be used for any purposes such as the following: UV protection and protection from weathering, scratch protection, mechanical protection, mechanical stability and thermal stability.

The protective layer is preferably a radiation-curing coating, preferably a UV-curing coating. UV-curing coatings are known and are described in the literature, for example P. K. T. Oldring (Ed.), Chemistry & Technology of UV & EB Formulations for Coatings, Inks & Paints, Vol. 2, 1991, SITA Technology, London, pp. 31-235, which is incorporated herein by reference. These are commercially available as pure material or as a mixture. The material is based on epoxide acrylates, urethane acrylates, polyester acrylates, acrylated poly-acrylates, acrylated oils, silicon acrylates, amine-modified and non-amine-modified polyether acrylates. In addition to acrylates or instead of acrylates, it is also possible to use methacrylates. Polymeric products which contain vinyl, vinyl ether, propenyl, allyl, maleyl, fumaryl, maleimide, dicyclopentadienyl and/or acrylamide groups as polymerizable components may furthermore be used. Acrylates and methacrylates are preferred. Commercially available photoinitiators may be present in an amount of from 0.1 to about 10% by weight, e.g. aromatic ketones or benzoin derivatives.

In a further embodiment, the protective layer comprises a plastic film which is coated with a coating. The plastic film is applied by pouring, coating with a doctor blade, spin coating, screen printing, spraying or lamination. The coating can be applied to the plastic film before or after this process step.

A suitable protective layer generally has the following properties: high transparency in the wavelength range from 750 to 300 nm, preferably from 650 to 300 nm, birefringence, nonscattering, amorphous, scratch-resistant, preferably measured by the pencil hardness test or other abrasion tests which are used by card manufacturers, a viscosity of, preferably, from about 100 mPa·s to about 100 000 mPa·s. Resins/coatings which shrink only slightly during exposure to light and have a weak double bond functionality and a relatively high molecular weight are particularly preferred. Particularly preferred material properties of the protective layers are therefore a double bond density below about 3 mol/kg, a functionality of less than about 3, very particularly preferably less than 2.5, and a molecular weight Mₙ greater than about 1000 and very particularly preferably greater than about 3000 g/mol.

The application of the liquid is effected by any known method such as by pouring, coating with a doctor blade and/or spin coating. The subsequent curing can be effected by exposure to light, preferably by uniform exposure to UV light.

Sunlight contains a broad wavelength spectrum and can result in the written information being slowly deleted again on exposure to sunlight. In order to prevent this, an absorbent which blocks wavelengths which are used neither for writing nor for reading the stored information, such as, for example, polymerizable merocyanine dyes (WO 2004/086390 A1, DE 10313173 A1, incorporated herein by reference in their entireties) or nanoparticles, can be introduced into a protective layer.

The storage layer can be used for the optical data storage. Data can be stored in digital form (e.g. as a bit sequence) or analogue form (e.g. as an image). It is possible to introduce data into the storage polymer as in the case of a CD or DVD. Preferably, however, data are stored holographically. Particularly preferably, data pages are stored holographically. The information may contain grey steps. The data pages preferably comprise a binary pattern (black/white pattern) since, in the reconstruction by reading the holographically stored data pages on a camera chip, this gives a readily detectable pattern that can be converted into an electronic signal and comprises light and dark regions. For example, bar codes or matrix codes or codes modified therefrom can be holographically stored. An overview of known binary codes is given, for example, in the following book: Roger C. Palmer, The Bar Code Book, publisher Helmers Pub; 4th edition (January, 2001), which is incorporated herein by reference. The code preferably contains an error correction, e.g. according to Reed-Solomon, in order nevertheless to be able to read the reproduced data page without errors in the event of bits reproduced incorrectly.

The holograms are preferably produced by superposing a reference beam and an object beam in the storage material. The object beam contains the information to be stored, preferably in the form of spatial amplitude modulation. This can be superposed on the object beam by means of a static photomask or by means of a programmable spatial light modulator (SLM). A programmable SLM is preferably used. This may be a liquid crystal microdisplay (LC), such as the LC 2002 (from Holoeye), an LCoS system (liquid crystal over silicon), such as the LC-R 2500 (from Holoeye), or a micromechanical mirror array, such as, for example, a DMD from Texas Instruments.

The object beam can be holographically stored by superposition with a reference beam in the storage material. Preferably, the Fourier transformation of the object beam is holographically stored since the resulting Fourier hologram has a translation variance which leads to easier readability owing to a higher tolerance in the positioning of the laser beam. The Fourier transformation is preferably produced physically by means of a Fourier lens.

Object beam and reference beam are preferably light beams which are circularly polarized in different directions and which, on superposition in the storage medium, produce linearly polarized light which determines the local orientation of the photoaddressable polymers. The reference beam can optionally also be provided with a modulation. This modulation acts as a cryptographic key, since reading of the hologram is possible only with the “correctly modulated” reference beam. The key can be superposed on the reference beam by amplitude or phase modulation. Preferably, the key is superposed by phase modulation. This means increased security. If the hologram were to be exposed to the object beam, the reference beam would be reconstructed. This means that, with the knowledge of a part of the stored data, a part of the key could be reproduced by exposure of the hologram with this part in the form of the corresponding amplitude modulation. If the key were to consist of an amplitude modulation, it could be visualized on a photoactive sensor. If the key consists of a phase modulation, it cannot be directly visualized since phases of a photoactive sensor cannot be registered, but only the intensity of a light beam which is proportional to the square of the amplitude.

Phase modulation can be carried out using an appropriate spatial light modulator. It is also possible to install a static phase mask in the reference beam path. This static phase mask could be, for example, a small glass plate into which a structure has been etched. Local path differences which effect a phase modulation can be superposed on the light which passes through the small glass plate by the structure. Phase modulation is preferably carried out using a programmable spatial light modulator (SLM). Such an SLM may be, for example, a liquid crystal microdisplay (LC), such as the LC 2002 (from Holoeye), an LCoS system (liquid crystal over silicon), such as the LC-R 2500 (from Holoeye), or a micromechanical mirror array, as developed, for example, at the Fraunhofer-Institut für Photonische Mikrosysteme.

Writing (exposure) is advantageously effected at a wavelength at which an oriented birefringence can be induced in the material. In the case of photoaddressable polymers having azobenzene side chains as a chromophore, the exposure takes place in the region of the adsorption band which is attributable to a π-π* electron transition in the azobenzene function. Writing is preferably effected into the flanks of the adsorption bands since it is here that the optical density of the system is lower and the exposure time is accordingly shorter than at the maximum of the adsorption band (cf. FIG. 6). Particularly preferably, writing is effected where the optical density is in the range from about 0.5 to 1.

The choice of the write and read wavelength of course also depends on the availability of appropriate laser sources. Particularly preferably, lasers having a wavelength of 532 nm (frequency-doubled Nd:YAG lasers) or 405 nm (blue laser diode) are used for writing, since these are commercially available. Surprisingly, it was found that holograms invisible to the human eye can be incorporated into a layer of an azobenzene-functionalized side-chain polymer by exposure. The energy input plays a decisive role, i.e. the quantity of energy which is introduced into the material over a defined period per unit area.

Also surprisingly, it was found that the product of intensity of the write beam and duration of the exposure time can be varied over a wide range for a layer comprising an azobenzene-functionalized side-chain polymer, provided that the product of intensity and duration (=energy input) is within a certain range. The energy input which is required in order to introduce invisible holograms into the storage medium is between two limits which can be determined experimentally.

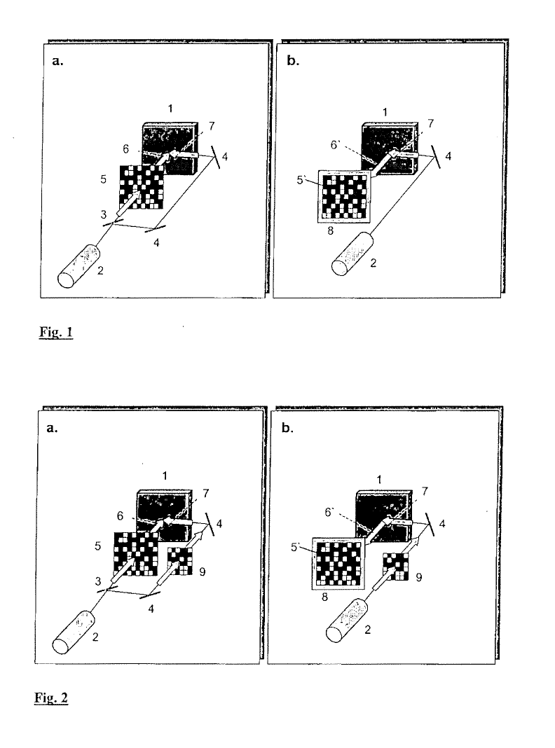

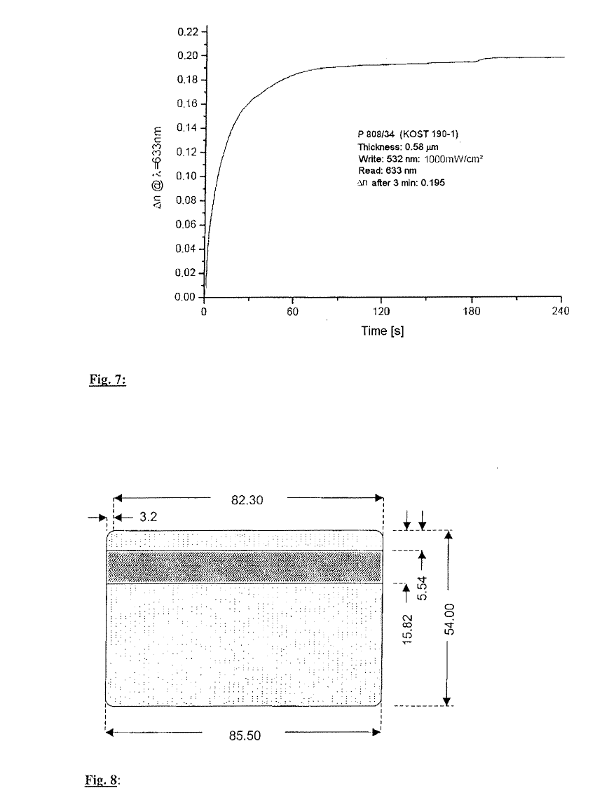

The lower limit is that at which it is possible to produce a stable birefringence which cannot be deleted thermally under normal environmental conditions (cf. in this context, for example, the ISO/IEC standard 9171-1 for optical disc memories) and is characterized by the saturation in the exposure curve (FIG. 7). FIG. 7 shows an exposure curve of an azobenzene-functionalized polymer. The chosen exposure intensity of 1000 mW/cm² is suitable for writing a stable structure into the polymer. The lower limit for producing a stable birefringence is 60 sec in this example. A shorter time and/or lower exposure intensity result in the written structure being unstable as a function of time, i.e. the oriented polymer molecules relax in the course of time. The exposure curve of a material can be recorded, for example, using an apparatus which is described in the following literature: R. Hagen, T. Bieringer; Photoaddressable Polymers for Optical Data Storage; Advanced Materials; WILEY-VCH Verlag GmbH (2001); No. 13/23; page 1807, FIG. 2, incorporated herein by reference.

The upper limit of the energy input is distinguished by the occurrence of surface structures which are visible to the human eye (cf. FIG. 12). This is observable in the case of excessively high intensity and/or excessively long exposure time, during which polymer molecules migrate into the light focus. This effect is described in the literature, for example in A. Natansohn, P. Rochon; Chem. Rev. 2002, 102, 4139-4175, incorporated herein by reference.

The application of a thin SiO₂ layer to the layer of the photoaddressable polymer enables the polymer to be fixed to a certain degree, with the result that the surface structuring is reduced (cf. Example 5.1). Instead of SiO₂, it is also possible to use other layers which are transparent to the write and read light, have low birefringence and are harder than the layer of photoaddressable polymer, such as, for example, Al₂O₃, TiO₂, SiC, etc.

Writing into an azobenzene-functionalized polymer by exposure can be supported by thermal treatment. According to DE 4431823 A1 (incorporated herein by reference), heating the storage material to a temperature between the glass transition temperature and the clearpoint leads to an amplification. Reading and writing are preferably effected at different wavelengths in order to prevent written data from being deleted during reading. Reading is preferably effected by using a reference beam of long-wave red light, particularly preferably by light having a wavelength in the range from 600 to 690 nm. The intensity of the read light is typically less than 10 mW/cm² in the case of incident broadband radiation and typically less than 10 mW/CM², preferably less than 1 mW/cm², in the case of incident narrow-band radiation.

The storage medium can be used, for example, in passes and ID cards in order to permit the verification of persons in combination with any desired biometric features. The storage medium can be used in a health card in order to provide the patient with medical information secure from unwanted reading. Many other applications are also envisioned that would be useful for the instant storage medium such as any application where a large amount of information needs to be collected and recalled without risk of falsification or unauthorized access or copying.

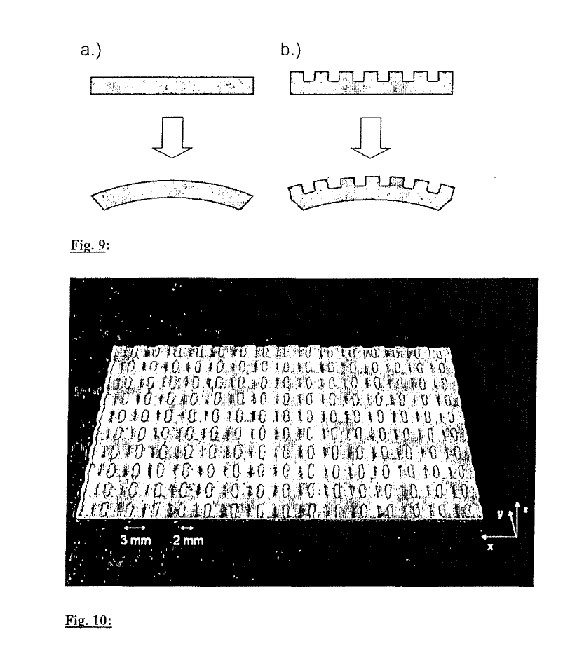

A particular embodiment of the present invention is therefore an identification storage medium, preferably an ID card. The shape, total thickness and size of the ID card are arbitrary and any are suitable. Reading requires only a smooth flat surface (Example 5), at least in the regions in which holograms are stored (Example 6, FIGS. 9, 10). The dimensions preferred in terms of marketing aspects for this particular ID card execution are analogous to the standard ISO/IEC 7810 (3rd edition of 2003-11-01, cf. FIG. 8). The yellow stripe in FIG. 8 is the storage layer. If required, the storage layer can be extended over the total card. However, it is also possible to provide only one region of the card with a storage layer if, for example, only a single hologram is stored.

In a particular embodiment of the present invention, markings which are intended to facilitate the finding of holograms are introduced into the substrate, since the polarization holograms are invisible. A structure in which there are regions which remain flat even when the body is bent, i.e. in which the bending remains limited to elements on which no holograms are written, is chosen. For example, it is also possible in the case of a single hologram to introduce a notch into the support around the hologram. On bending of the support, the notch is increased in size but the region of the hologram remains substantially flat. However, the structure of the card is particularly suitable.

In a further particular aspect of the present invention, the card is therefore structured with nub structuring. Since the correct reading of stored holograms requires a smooth, flat surface, it is possible that, if the card is curved as a result of bending, the image reproduced is no longer correctly focused on the photosensitive sensor (camera chip). In order to prevent this, the card is structured with a nub structure, for example as shown in FIG. 9, since this causes the raised regions to remain flat even when the card is bent (cf. also Example 6, FIG. 10). One or more holograms can be stored on the raised regions.

The nub structuring can be effected by any desired way, such as: by milling, cutting, lithography, laser sintering, moulding, casting methods (e.g. injection moulding or vacuum casting) and/or other methods by means of which patterns can be introduced into polymer or metal bodies. The nub structuring is preferably in the form of square, hexagonal or round elevations, preferably in the size from about 0.1 mm to about 5 mm in diameter, with a spacing of about 0.1 to about 2 mm. Particularly preferably, a nub structuring which is at least the size of a single hologram is introduced into the support.

In a particular execution, further storage media are integrated into the card in addition to the PAP storage layer. In a specific embodiment, the ID card is additionally equipped, for example, with an RFID chip. In the case of a pure PAP-ID card, the authentification must be initiated by inserting the card into a reader. The drawing-in of the card, reading of the data and ejection of the card require a certain time. An RFID card is read “in passing” by radio. The authentification is faster. If a building is equipped with various security sectors, it may be advantageous to provide the sectors which have to be less protected with an “RFID authentification” while the high-security sectors are accessible only via the PAP-ID card with stored biometric features. In this case, a card having a PAP layer and RFID chip performs both functions.

Likewise, in another specific embodiment of the present invention, the ID card is additionally provided with a microprocessor chip with which a digital signature can be created. This is expedient, for example, in the case of health cards. By means of the digital signature, the user can show that he or she is the owner/holder of the card, while the large quantity of data relating to medical information are stored holographically on the card, protected from unwanted access.

The storage medium is preferably used in passes and in plastic cards for identification purposes, i.e. ID cards. The storage medium according to the invention is particularly suitable for sensitive data, confidential data and/or data worthy of protection. Preferably, biometric features for verification of persons are holographically stored and make the use of the storage medium for access control and as a health card particularly secure. Use of the storage medium in visas or other paper documents which contain information worthy of protection is also intended.

The following list the reference numeral designations from the drawings.

1 Holographic storage layer

2 Laser source

3 Beam guide

4 Mirror

5 Data mask

5′ Reconstructed data mask

6 Information beam

6′ Reconstructed information beam

7 Reference beam

8 Detector (camera)

9 Key

10 Protective layer

11 Reflection layer

12 Substrate

### EXAMPLES

### Example 1 (Polymer Synthesis)

Photoaddressable Polymer:

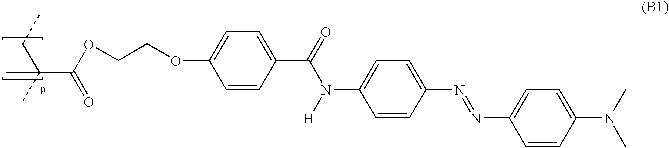

The synthesis is described in WO9851721 (page 24, lines 10-15, and page 26, line 20 to page 27, line 5), incorporated herein by reference.

### Example 2 (Preparation of the Polymer Solution)

15.0 g of polymer B1 were dissolved in 100 ml of cyclopentanone at 70° C. The solution was cooled to room temperature and filtered through a 0.45 μm and then through a 0.2 μm Teflon filter. The solution remained stable at room temperature and was used for the application of polymer B1 to various surfaces, such as, for example, to polymeric surfaces and to metallized polymer surfaces.

### Example 3 (Coating of Glass and Plastic Surfaces with Photoaddressable Polymers)

3.1 Coating of Glass Substrates

The coating of 1 mm thick glass substrates was carried out with the aid of spin coating. A “Karl Süss CT 60” spin coater was used. A square glass substrate (26×26 mm²) was fixed on the rotating platform of the apparatus, covered with the solution from Example 2 and rotated for a certain time. Depending on the rotation programme of the apparatus (acceleration, speed and time of rotation), transparent, amorphous coatings of optical quality having a thickness of 0.2 to 2.0 μm were obtained. By storing the coated glass substrate for 24 h at room temperature in a vacuum cabinet, residues of the solvent were removed from the coatings.

3.2 Coating of PET Films

A solution from Example 2 was applied by means of a manual doctor blade to a 125 μm thick PET film (Melinex® from Dupont).

After drying of the coated film for 24 h in a vacuum cabinet at room temperature, an approximately 5 μm thick polymer layer was obtained. The layer thickness can be reduced by diluting the solution.

3.3 Coating of Polycarbonate Films

Direct coating of polycarbonate films (PC film, e.g. Makrofol® from Bayer Material Science) is not possible since the solvent used in the polymer solution from Example 2 (cyclopentanone) attacks polycarbonate.

For this reason, 175 μm thick Makrofol® PC film was first provided with a 1 μm thick Parylene layer (poly-p-cyclophane) by a coating (PPCS). This acts as a barrier layer through which cyclopentanone cannot penetrate during coating with the polymer solution. The polymer was applied by spin coating to a 3×3 mm² Parylene-coated film section as described in Example 3.2.

### Example 4 (Coating of Metallized Polymer Films)

4.1 Metallization of PC and PET Films

PC films (Bayer Makrofol®) and PET films (Dupont Melinex®, Dupont Mylar®, Toray Lumirror®) having different thicknesses were coated. Silver was used as a reflection layer and was applied by means of magnetron sputtering. The Ar pressure during coating was 5×10⁻³ mbar. Sputtering was effected with a power density of 1.3 W/cm². The layer thickness was measured using a mechanical profilometer Alpha-step 500 (from Tencor). The thickness was set between 100 and 400 nm.

4.2 Application of Photoaddressable Polymers Directly onto a Metal Coating from Example 4.1

The photoaddressable polymer from Example 1 was applied analogously to Example 3.1 by spin coating or analogously to Example 3.2 by application of a doctor blade from the solution from Example 2 directly onto one of the metallized PET films from Example 4.1. On spin coating, a transparent, amorphous coating of optical quality having a thickness of 0.2 to 2.0 μm was obtained depending on the rotation programme of the apparatus (acceleration, speed and time of rotation).

The metal coatings of polycarbonate films, the thickness of which is between 50 and 300 nm, have reflective properties which are sufficient for optical or holographic storage but do not have adequate barrier functions against solvents. Cyclopentanone, for example, attacks the polycarbonate through the numerous microdefects (pinholes) of these metal coatings, which leads to a considerable reduction in the optical quality of the storage layer.

In this case, the thickness of the metal layer must be increased to more than 300 nm. Such a layer thickness has adequate barrier properties. Coating with polymer is effected directly onto the metal layer in a manner analogous to that described above for PET films.

Alternatively, a Parylene barrier layer was applied between the metal layer and the PC film. The Parylene coating of PC is described in Example 3.3. The metal was applied directly to the Parylene layer by sputtering analogously to Example 4.1. The coating with polymer is effected directly onto the metal layer analogously to the procedure above for PET films.

### Example 5

### Production of a Storage Medium

The plastic films according to Example 4, coated with photoaddressable polymers, were coated on the PAP side and optionally additionally on the side of the plastic film or covered with films. These coatings/films improve the mechanical load capacity and protect the information layer from mechanical and other (heat, light, moisture) influences. The layers can be applied by vacuum coating, lacquering or lamination.

5.1 Covering of the Photoaddressable Polymer Layer with Silica

A silica coating was applied as an outer protective layer. SiO₂ particles having a diameter of about 200 nm were deposited as a transparent protective layer on the PAP layer of a film from Example 4.2 by means of an electron beam evaporator. The power of the electron beam was 1.5 kW and the process was carried out in a high vacuum at a pressure of 5×10⁻⁷ mbar.

5.2 Application of a UV-Curable Lacquer

A layer of UV-curable lacquer was additionally applied to the silica coating from Example 5.1. The lacquer layer was applied in the form of a DVD adhesive “DAICURE CLEAR SD-645” from DIC Europe GmbH by spin coating analogously to Example 4.2 and was cured by UV exposure (90 watt; 312 nm). By appropriate adaptation of the rotation programme of the spin coater (acceleration, speed and time of rotation), transparent, amorphous, 50 μm thick coatings of optical quality were obtained. The coatings could be adjusted to a thickness from 1 to 100 μm depending on the rotation programme of the spin coater.

5.3 Protection of the PAP Layer by a Polycarbonate Film

The film layers produced according to Example 4.2 were laminated with a structured or smooth polycarbonate film in a hydraulic hot press from Bürkle type LA 62, the PAP layer being covered by the polycarbonate film. The lamination was effected between two polished stainless steel plates (reflective sheet metal) and a pressure equalization layer (press cushion). The lamination parameters (temperature, time, pressure) were adjusted so that the PAP coating showed no visible damage.

5.4 Application of the Storage Medium to a Further Support

The layer structures described in Examples 4.2, 5.1, 5.2 and 5.3 were applied to further supports. They were applied by means of adhesive bonding to PVC films. The result is a data medium which withstands mechanical loads.

### Example 6 (Production of a Structured Card)

Formpool was commissioned to produce a card having 3 mm wide square nubs with a spacing of 2 mm and a nub height of 0.5 mm (cf. FIG. 10). The card height was 1 mm altogether. The card was produced from polyurethane by a rapid prototyping method (vacuum casting). The card was provided with a silver layer and a photoaddressable polymer analogously to Example 4 and with a protective layer analogously to Example 5 and inscribed with holograms analogously to Example 7, the holograms being placed on the elevations (nubs).

### Example 7 (Exposure)

A 750 μm thick polycarbonate film (Makrolon® DE 1-1) was used as a storage card and was provided with the following layers analogously to Examples 4.1, 4.2 and 5.1: with a 1 μm thick Parylene layer, a 0.1 μm thick silver layer, a 1.6 μm thick layer of a photoaddressable polymer and a 0.15 μm thick SiO₂ layer (in the sequence stated).

7.1 Local Birefringence

Local birefringence was introduced into the storage card by exposure to light. The apparatus used for this purpose is as described, for example, in: R. Hagen, T. Bieringer; Photoaddressable Polymers for Optical Data Storage; Advanced Materials; WILEY-VCH Verlag GmbH (2001); No. 13/23; page 1807; FIG. 2, which is incorporated herein by reference. A region of about 1 mm² (spot size 1 mm²) was exposed using a frequency-doubled Nd:YAG laser (532 nm) in the CW mode. The birefringence written in was read using a diode laser (605 nm, 5 mW).

Exposure was effected firstly for 20 sec with 50 mW (=1 J) and secondly for 400 msec with 2.5 W (=1 J). In both cases, the change in the refractive index was about 0.2.

7.2 Holographic Exposure

The exposure was carried out by Optilink Kft. using an apparatus as described in the application WO 99/57719 A1 (page 10, line 1 to page 14, line 16), incorporated herein by reference. The write laser used was a frequency-doubled Nd:YAG laser having a wavelength of 532 nm.

The size of the hologram written was 0.2 mm (diameter), the laser power was 300 uW, the exposure time was 60 sec and about 5 KB of data were stored.

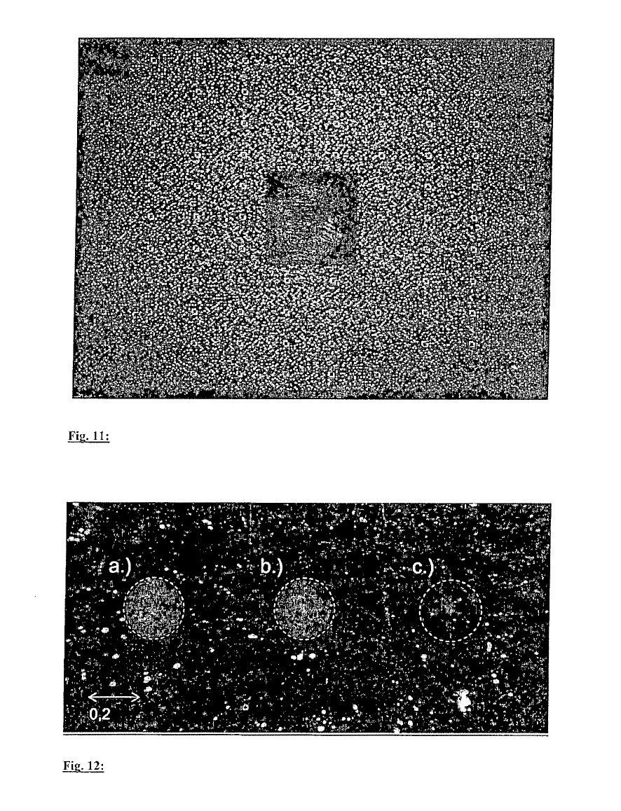

The hologram written could be successfully read in the R/W unit using the Nd:YAG laser at an intensity of 10 mW/cm². The image of the holographically stored data page, reconstructed on a camera chip, is shown in FIG. 11. The hologram was invisible to the eye; the data could still be read without problems even after 2 months (the birefringence written in is stable as a function of time).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” connote the singular or plural.

What is claimed is:

1. An optical storage medium for storing data comprising at least one layer comprising a photoaddressable polymer, wherein data in the form of at least one polarization hologram invisible to the human eye is incorporated into the layer by exposure.

2. An optical storage medium according to claim 1, further comprising at least one feature that facilitates optical discovery of the hologram.

3. An optical storage medium according to claim 1, that is present in the form of a plastic card.

4. An optical storage medium according to claim 3, further comprising a structure incorporated into the plastic card, wherein, when said structure is bent, parts of the card which are provided with at least one hologram have a smaller curvature than the curvature of the total card body.

5. A method for incorporating at least one hologram into a storage medium according to claim 1 comprising: conducting an exposure, wherein an energy input of a writing beam is between at least two limits, one limit being a higher limit and one limit being a lower limit, and wherein an energy input above the higher limit leads to the formation of visible surface structures in the layer of photoaddressable polymer and an energy input below the lower limit leads to birefringent structures which are not stable as a function of time.

6. A method according to claim 5, wherein the limits for the photoaddressable polymer used are determined empirically.

7. A method for storing and/or protecting information comprising using a storage medium according to claim 1.

8. A method for identifying a subject comprising using a storage medium according to claim 1.

9. An optical storage medium of claim 1 comprising at least three layers comprising a substrate, a storage layer of said photoaddressable polymer and at least one protective layer.

10. An optical storage medium of claim 9 further comprising at least one reflection layer.

11. An optical storage medium of claim 1 wherein said photoaddressable polymer comprises a polymer having an azobenzene-functionalized side chain.

12. An optical storage medium of claim 9 wherein said photoaddressable polymer comprises a polymer having an azobenzene-functionalized side chain.

13. An optical storage medium of claim 11, wherein upon exposure to polarized light, azobenzene groups are aligned perpendicular to the direction of polarization.

14. An optical storage medium of claim 1 wherein the hologram is at least 0.01 sq. mm.

15. An optical storage medium of claim 1 wherein said at least one hologram is produced by superposing a reference beam and an object beam in the storage medium.

16. An optical storage medium of claim 11 wherein said at least one hologram is incorporated into a layer of an azobenzene-functionalized side chain polymer.

17. An optical storage medium of claim 12 wherein said at least one hologram is incorporated into a layer of an azobenzene-functionalized side chain polymer.

18. An optical storage medium of claim 1 further comprising an SiO₂ layer adjacent to said layer of photoaddressable polymer.

19. An optical storage medium of claim 1 further comprising at least one further layer transparent to write and read light and that is harder than the layer of photoaddressable polymer.

20. A method of claim 5 wherein reading and writing are effected a different wavelengths in order to minimize data from being deleted during reading.
